(19) United States
(12) Patent Application Publication
(10) Pub. No.: US 2016/0109059 A1
(43) Pub. Date: Apr. 21, 2016

(54) Object Mounting System

(71) Applicant: James K. Richards, III, Spring Hill, FL (US)

(72) Inventor: James K. Richards, III, Spring Hill, FL (US)

(21) Appl. No.: 14/519,873

(22) Filed: Oct. 21, 2014

(51) Int. Cl. F16M 13/02; F16B 11/00

(52) U.S. Cl. CPC F16M 13/022; F16B 11/006

(57) ABSTRACT

An object mounting system for effectively attaching an object to a mounting surface without damaging the mounting surface. The object mounting system generally includes a support base having a bottom portion having a bottom surface and an upper portion, an adjustment member adjustably positioned within the upper portion of the support base to allow for adjustment of an attitude of the adjustment member and an object member removably attached to the adjustment member. A protective sticker having an upper protective surface and a lower adhesive surface is attached to a mounting surface to protect the mounting surface. An adhesive tape having an upper adhesive side and a lower adhesive side is attached between the bottom surface of the support base and the upper protective surface of the protective sticker to secure the support base.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an object mounting apparatus and more specifically it relates to an object mounting system for effectively attaching an object to a mounting surface without damaging the mounting surface.

2. Description of the Related Art

Any discussion of the related art throughout the specification should in no way be considered as an admission that such related art is widely known or forms part of common general knowledge in the field.

Attaching object members to a mounting surface with adhesive tape is well known. One example is attaching hood ornaments to the upper surface of a vehicle hood. However, attaching an object member to a surface of a vehicle hood or other important surface may result in damage to the surface if the object member is removed thereby leaving the entire adhesive tape or portions of the adhesive tape connected to the surface.

Another problem involves attaching an object member to uneven mounting surfaces such as the center ridge of a vehicle hood since the bottom of the object member is unable to be properly attached to the adhesive tape.

Because of the inherent problems with the related art, there is a need for a new and improved object mounting system for effectively attaching an object to a mounting surface without damaging the mounting surface.

### BRIEF SUMMARY OF THE INVENTION

The invention generally relates to an object mounting apparatus which includes a support base having a bottom portion having a bottom surface and an upper portion, an adjustment member adjustably positioned within the upper portion of the support base to allow for adjustment of an attitude of the adjustment member and an object member removably attached to the adjustment member. A protective sticker having an upper protective surface and a lower adhesive surface is attached to a mounting surface to protect the mounting surface. An adhesive tape having an upper adhesive side and a lower adhesive side is attached between the bottom surface of the support base and the upper protective surface of the protective sticker to secure the support base.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention.

FIG. 3 is a front view of the present invention.

FIG. 4 is a side view of the present invention.

FIG. 5 is a top view of the present invention.

FIG. 6 is a bottom view of the present invention.

FIG. 7 is a side view of the present invention illustrating the object member being adjusted.

FIG. 8a is a cross section view taken along line 8-8 of FIG. 3 with the protective sticker and the adhesive tape.

FIG. 8b is an exploded side cutaway view of the present invention.

FIG. 9 is a side cutaway view of the present invention with the object member adjusted into a different position.

FIG. 10a is an exploded upper perspective view of the present invention with respect to a mounting surface comprised of a vehicle hood.

FIG. 10b is an exploded upper perspective view of the present invention with the protective sticker attached to the mounting surface.

FIG. 10c is an upper perspective view of the present invention attached to the mounting surface.

FIG. 11 is an upper perspective view of the present invention attached to a curved mounting surface of a helmet.

### DETAILED DESCRIPTION OF THE INVENTION

### A. Overview

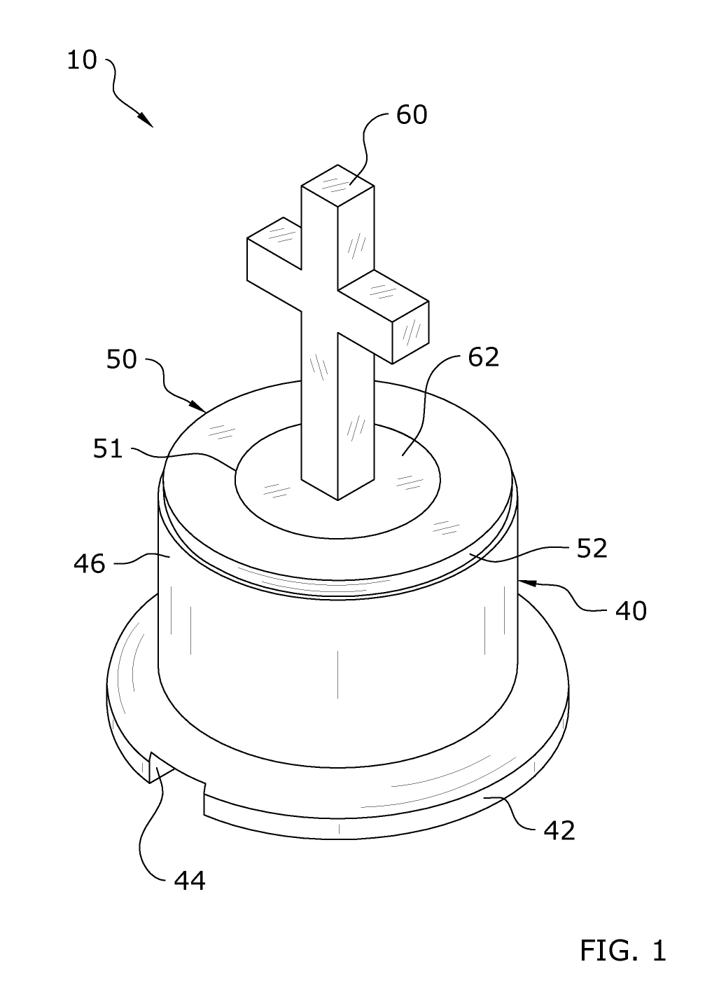

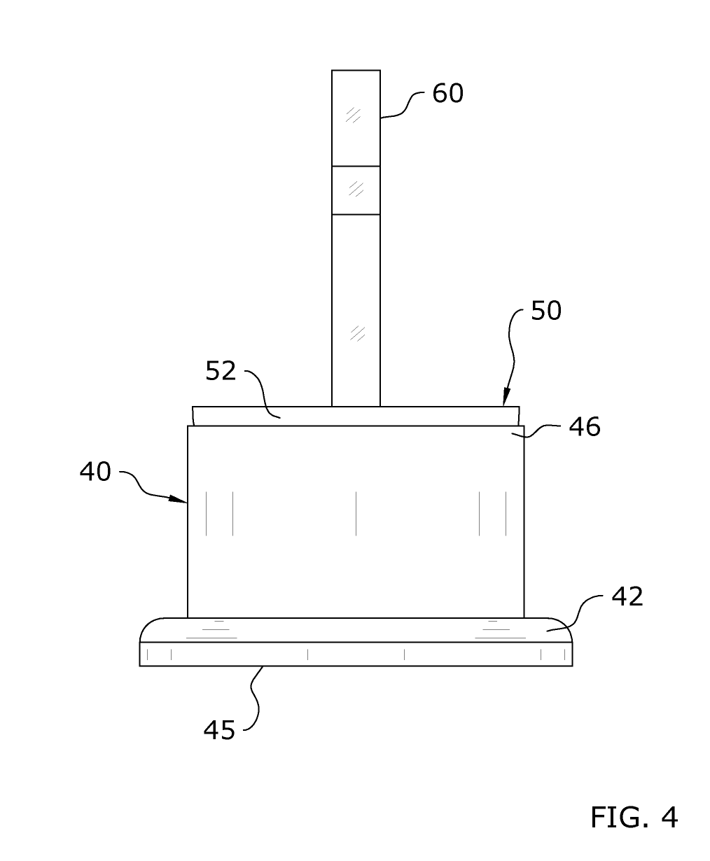

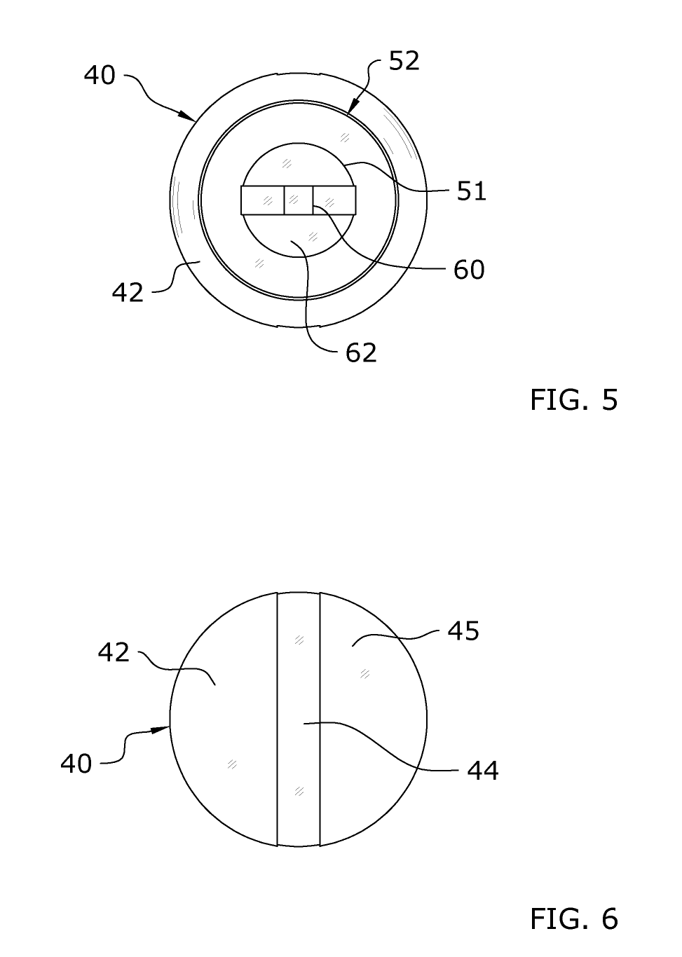

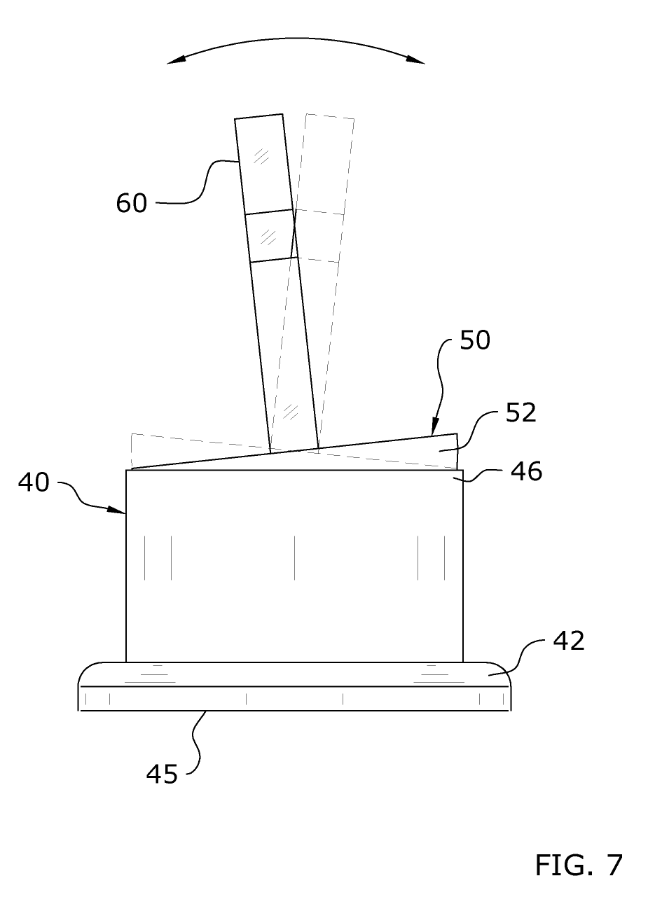

Turning now descriptively to the drawings, in which similar reference characters denote similar elements throughout the several views, FIGS. 1 through 11 illustrate an object mounting system 10, which comprises a support base 40 having a bottom portion 42 having a bottom surface 45 and an upper portion 46, an adjustment member 50 adjustably positioned within the upper portion 46 of the support base 40 to allow for adjustment of an attitude of the adjustment member 50 and an object member 60 removably attached to the adjustment member 50. A protective sticker 20 having an upper protective surface 22 and a lower adhesive surface 24 is attached to a mounting surface 12 to protect the mounting surface 12. An adhesive tape 30 having an upper adhesive side 32 and a lower adhesive side 34 is attached between the bottom surface 45 of the support base 40 and the upper protective surface 22 of the protective sticker 20 to secure the support base 40.

### B. Support Base

FIGS. 1 through 11 illustrate an exemplary support base 40 having a bottom portion 42 having a bottom surface 45 and an upper portion 46 extending upwardly from the bottom portion 42. The bottom portion 42 and the upper portion 46 may have the same width. However, it is preferable that the bottom portion 42 of the support base 40 is broader than the upper portion 46 to provide additional stability for supporting the object member 60. The support base 40 may be comprised of various types of materials including but not limited to plastic, metal, composite or wood. The support base 40 may have various cross sectional shapes such as, but not limited to, circular, square, rectangular and triangular. The object member 60 may be directly attached to the support base 40 or attached to the support base 40 using an adjustment member 50.

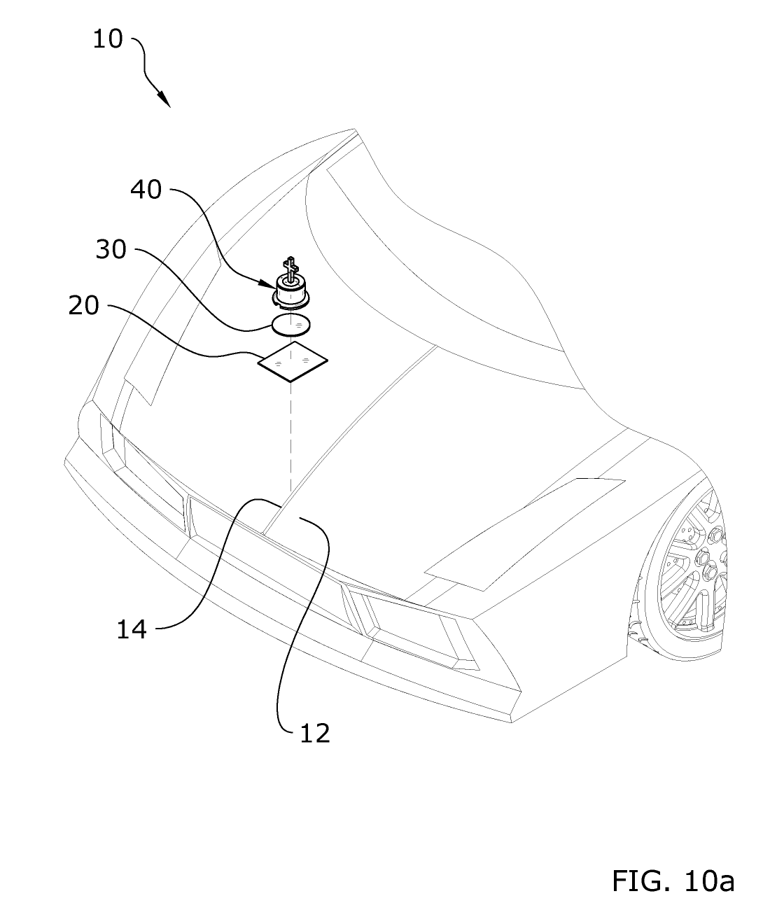

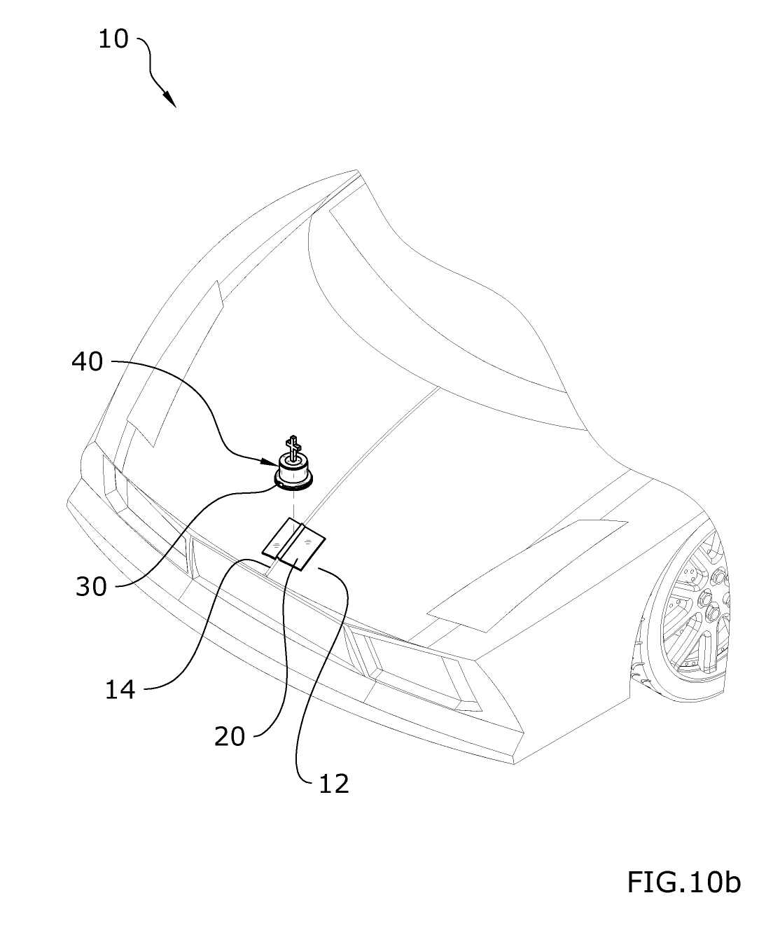

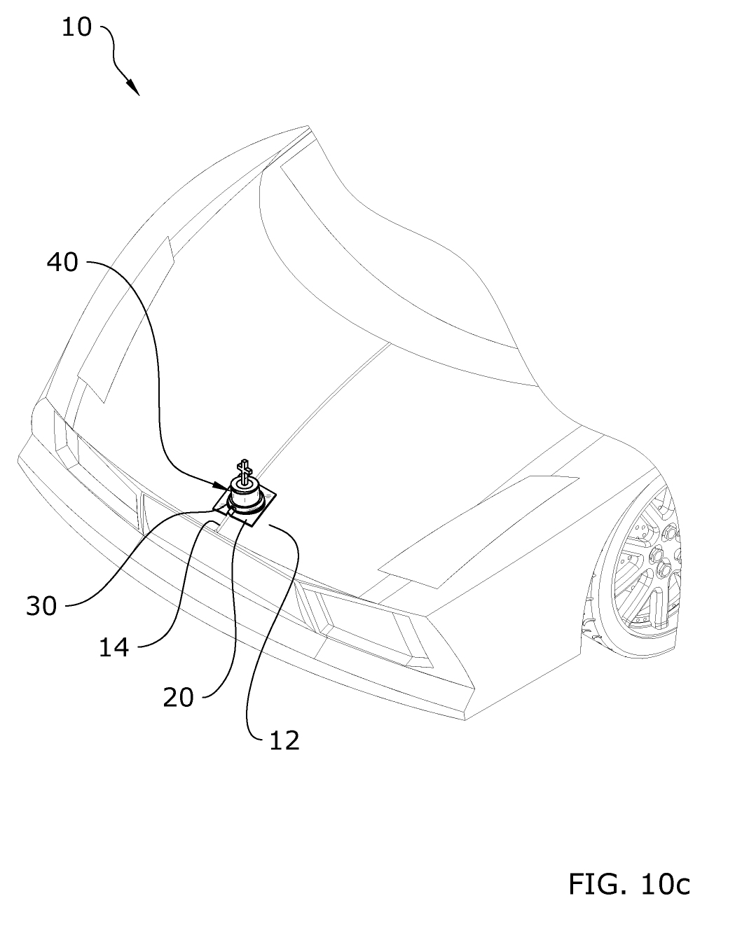

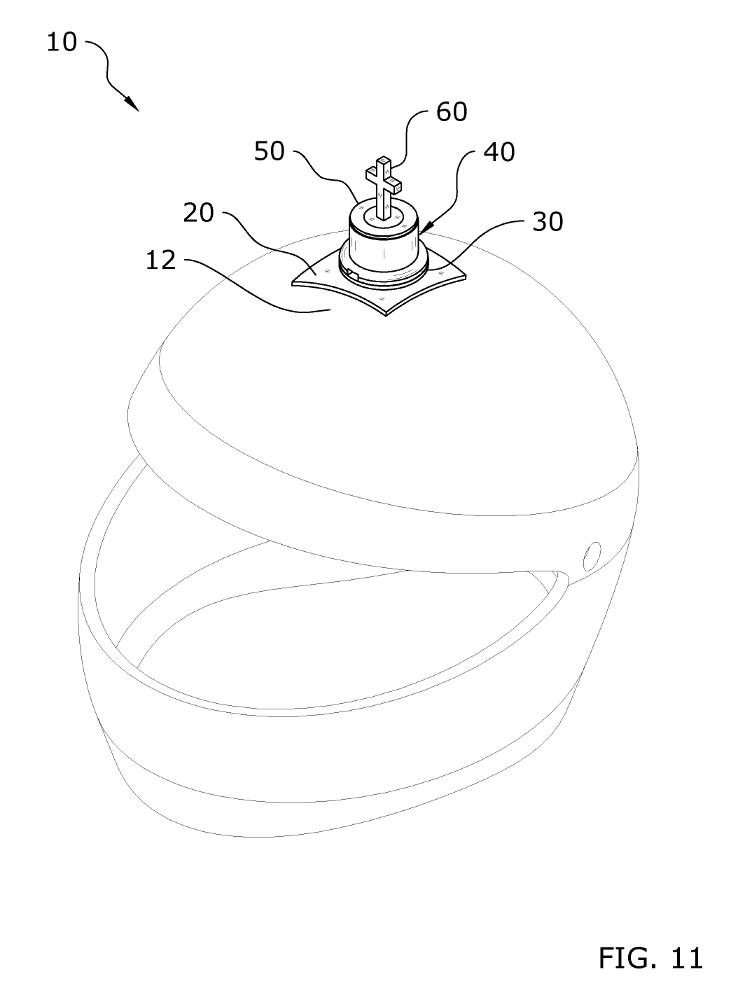

The upper portion 46 includes an interior portion that is preferably curved that adjustably receives an adjustment member 50. The bottom portion 42 of the support base 40 preferably includes a passage 44 that extends into the bottom surface 45 of the support base 40 to allow for attachment of the support base 40 to a mounting surface 12 that has a raised portion 14 (e.g. a center ridge of a vehicle hood as illustrated in FIGS. 10a through 10c of the drawings or a curved surface such as a helmet as illustrated in FIG. 11). The raised portion 14 of the mounting surface 12 extends upwardly into the passage 44 thereby allowing the two opposing side portions of the bottom portion 42 of the support base 40 to securely be attached to opposing sides of the raised portion 14 upon the mounting surface 12 as illustrated in FIG. 10c of the drawings.

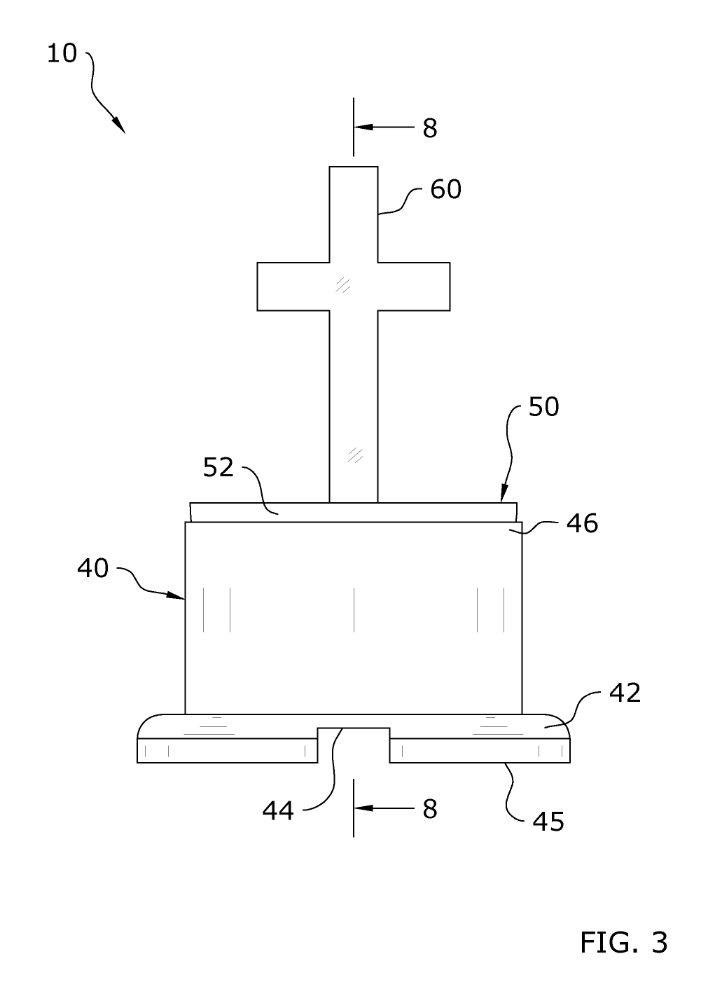

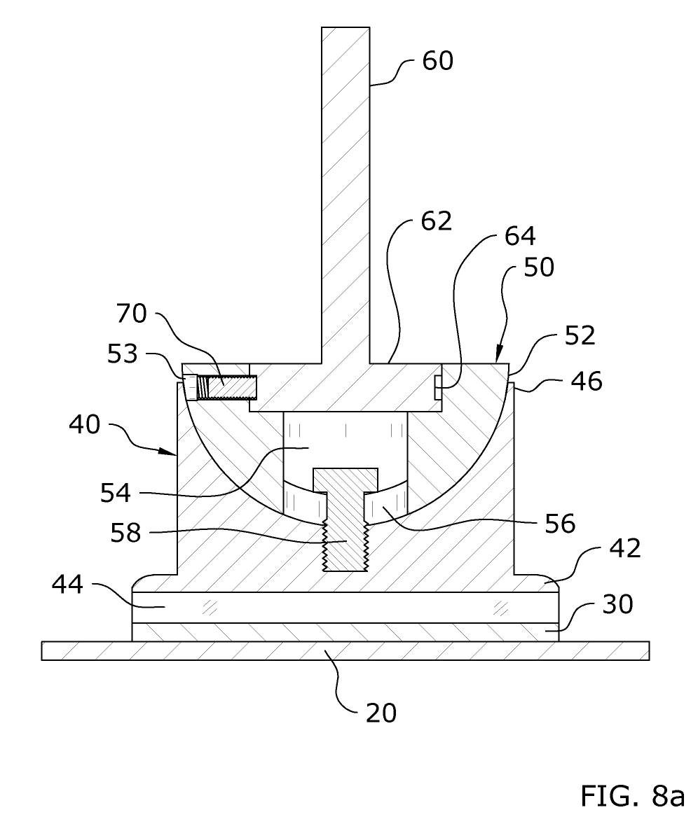

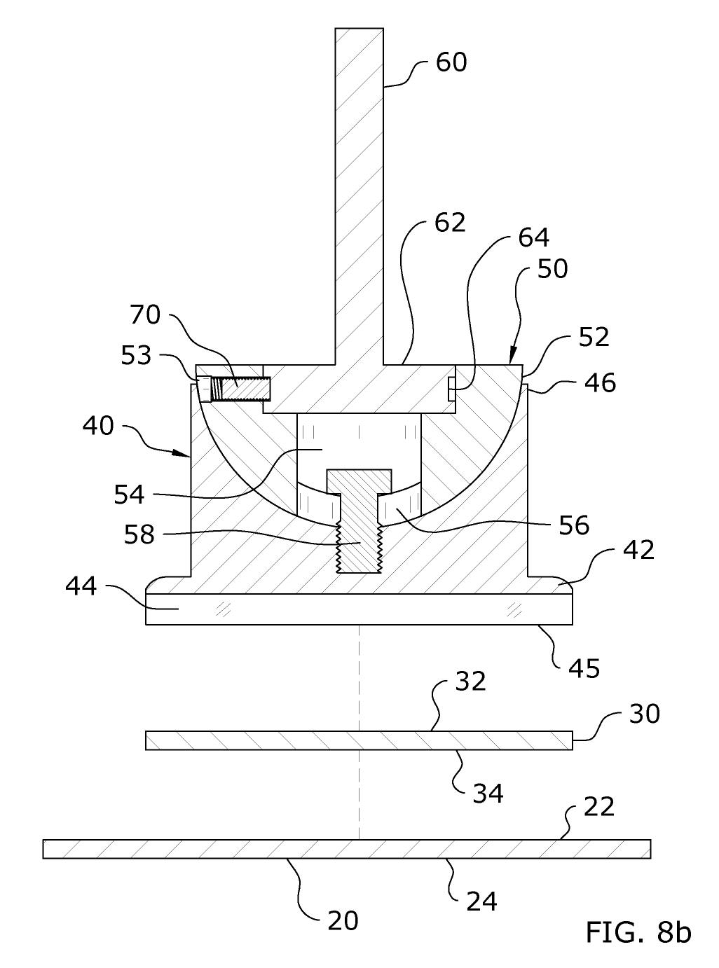

The passage 44 extends between opposing ends of the support base 40 wherein the passage 44 is preferably exposed on both opposing ends of the support base 40 as illustrated in FIGS. 3 and 8a of the drawing. The passage 44 is preferably comprised of a straight configuration as illustrated in FIG. 6 of the drawings. The passage 44 may have various cross sectional shapes such as rectangular (see FIG. 3), curved, triangular and the like.

### C. Adjustment Member

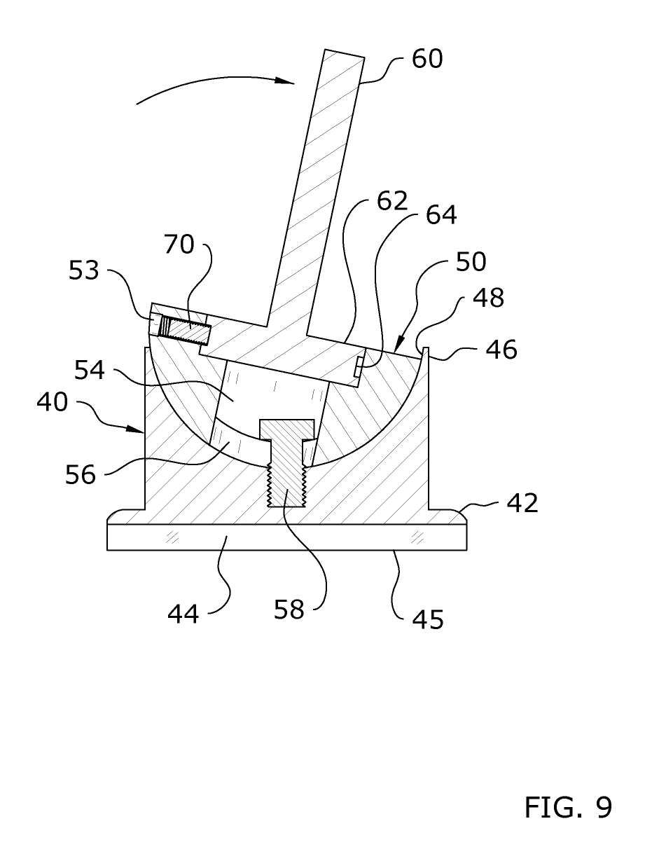

The adjustment member 50 is adjustably positioned within the upper portion 46 of the support base 40 to allow for adjustment of an attitude of the adjustment member 50. FIGS. 8a and 9 illustrate examples of the different positions for the adjustment member 50 along with the object member 60 attached to the adjustment member 50. The adjustment of the position of the adjustment member 50 allows for adjustment of the alignment of the object member 60 to accommodate for various angled mounting surfaces 12 (e.g. to compensate for a forward downwardly sloping hood of a vehicle). The adjustment member 50 may be moved in various directions and attitudes.

The adjustment member 50 includes a curved outer surface 52 that has approximately the same radius of curvature as an interior surface of the interior curved portion 48 for the upper portion 46 of the support base 40 as best illustrated in FIGS. 8a through 9 of the drawings. The adjustment member 50 includes an upper opening 51 that is adapted to removably receive an object member 60 in a catchable manner. The object member 60 may be permanently or removably attached to the adjustment member 50.

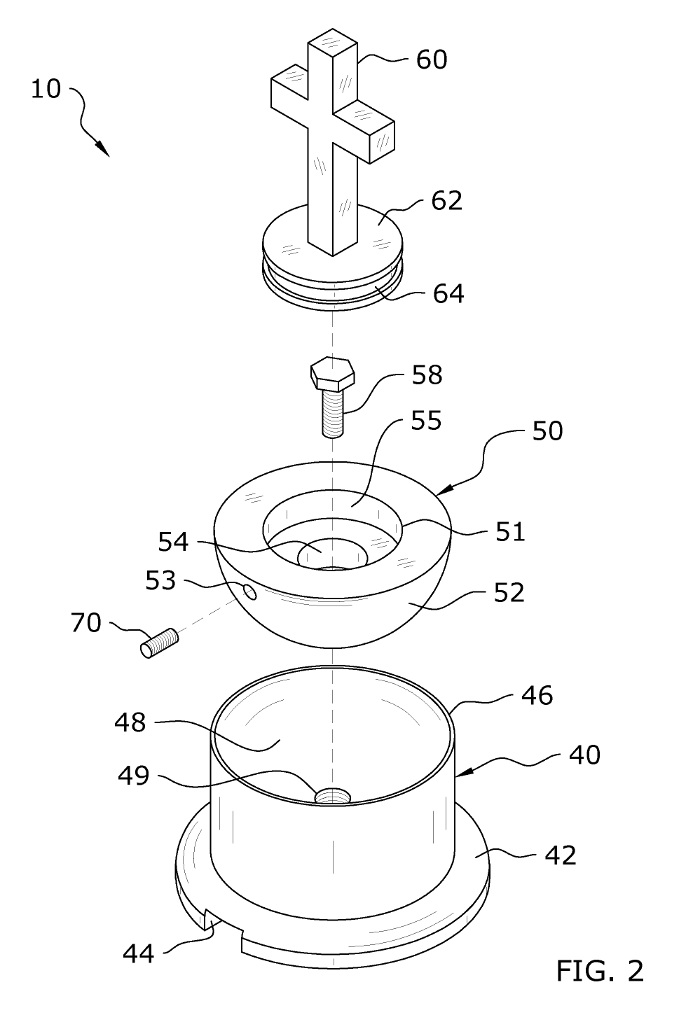

The adjustment member 50 includes a recessed portion 55 exposed by the upper opening 51 that removably receives an object base 62 of the object member 60 as best illustrated in FIGS. 2, 8a through 9 of the drawings. An aperture 53 extends through a side portion of the adjustment member 50 to receive a securing pin 70 that extends through the aperture 53 into a groove 64 within an outer sidewall of the object base 62 to selectively retain the object member 60 attached to the adjustment member 50. The aperture 53 is preferably interiorly threaded and the securing pin 70 is preferably exteriorly threaded to provide for threaded engagement between thereof wherein a user is able to extend the securing pin 70 into the groove 64 of the object base 62 to secure within the adjustment member 50 or extend outwardly to allow for removal of the object member 60. More than one aperture 53 and securing pin 70 combination may be utilized to provide for securing of the object member 60 within the adjustment member 50.

The adjustment member 50 includes an interior cavity 54 exposed by the upper opening 51 and an adjustment opening 56 that extends through a bottom portion 42 of the adjustment member 50 as best illustrated in FIGS. 8a and 8b of the drawings. A fastener 58 extends through the adjustment opening 56 to secure the adjustment member 50 in a desired attitude with respect to the upper portion 46 of the support base 40. The fastener 58 is preferably a threaded shaft structure with a broad end (e.g. a bolt) that is threadably received within a threaded aperture 49 at the bottom of the interior curve portion of the upper portion 46 of the support base 40. The adjustment opening 56 is further broader than the diameter of the fastener 58 to allow for adjustment of the adjustment member 50 with respect to the upper portion 46 of the support base 40 and is further preferably comprised of a slot that is aligned with the passage 44 within the support base 40.

### D. Object Member

The object member 60 is removably attached to the adjustment member 50 or directly to the upper portion 46 of the support base 40. The object member 60 may be permanently attached to the adjustment member 50 or the support base 40. The object member 60 may be comprised of any object such as an ornamental object (e.g. a hood ornament, a cross), an electronic device (e.g. a camera, a video recorder, a mobile phone) or other object. The object member 60 includes an object base 62 that is attached to the adjustment member 50 and includes the groove 64 that receives the securing pin 70 for selectively securing the object member 60. The object member 60 may be removed and replaced with a different object member 60 by removing the securing pin 70 as the user desires.

### E. Protective Sticker

The protective sticker 20 has an upper protective surface 22 and a lower adhesive surface 24. The lower adhesive surface 24 is removably attached to the mounting surface 12 for any type of object (e.g. the hood of a vehicle, surfboard, desk, motorcycle, snowmobile etc.). The protective sticker 20 is preferably comprised of a paint protection film such as 3M SCOTCHGUARD PAINT PROTECTION FILM PRO SERIES manufactured by 3M Company.

The upper protective surface 22 of the protective sticker 20 is preferably comprised of a plastic film such as, but not limited to, a urethane film. The upper protective surface 22 of the protective sticker 20 is preferably larger in area than the lower adhesive side 34 of the adhesive tape 30 to ensure that the lower adhesive side 34 does not directly contact the mounting surface 12 (e.g. the paint of the vehicle hood). The protective sticker 20 is preferably thinner than the adhesive tape 30. The protective sticker 20 is also preferably comprised of a transparent and flexible material to reduce the likelihood of viewing by an individual.

### F. Adhesive Tape

The adhesive tape 30 has an upper adhesive side 32 that is adapted to attach to the bottom surface 45 of the support base 40 and a lower adhesive side 34 that is adapted to removably attach to the upper protective surface 22 of the protective sticker 20. The adhesive tape 30 is preferably comprised of a permanent assembly tape such as 3M VHB PERMANENT ASSEMBLY TAPE. The adhesive tape 30 is further preferably comprised of a dual-sided acrylic foam tape and further preferably comprised of a pressure sensitive acrylic foam tape.

### G. Operation of Preferred Embodiment

In use, the user first attaches the lower adhesive surface 24 of the protective sticker 20 to the mounting surface 12 as illustrated in FIG. 10b of the drawings. The user then attaches the upper adhesive side 32 of the dual-sided adhesive tape 30 to the bottom surface 45 of the support base 40 as further illustrated in FIG. 10b of the drawings. The user then secures the lower adhesive side 34 of the adhesive tape 30 to the upper protective surface 22 of the protective sticker 20 without touching the mounting surface 12 with the adhesive tape 30. The raised portion 14 of the mounting surface 12 extends upwardly into the passage 44 thereby ensuring a complete connection between the adhesive tape 30 and the upper protective surface 22. If the user desires to remove the support base 40, the user physically removes the support base 40 wherein the adhesive tape 30 is removed from the upper protective surface 22 of the protective sticker 20. The user may then remove the protective sticker 20 if desired or leave the protective sticker 20 upon the mounting surface 12.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An object mounting system, comprising:
a support base having a bottom portion having a bottom surface and an upper portion adapted to support an object member;
a protective sticker having an upper protective surface and a lower adhesive surface, wherein said lower adhesive surface removably attaches to a mounting surface; and
an adhesive tape having an upper adhesive side that is adapted to attach to said bottom surface of said support base and a lower adhesive side that is adapted to removably attach to said upper protective surface of said protective sticker.

2. The object mounting system of claim 1, wherein said adhesive tape is comprised of an acrylic foam tape.

3. The object mounting system of claim 1, wherein said adhesive tape is comprised of a pressure sensitive acrylic foam tape.

4. The object mounting system of claim 1, wherein said adhesive tape is comprised of a permanent assembly tape.

5. The object mounting system of claim 1, wherein said protective sticker is comprised of a paint protection film.

6. The object mounting system of claim 1, wherein said upper protective surface is comprised of a plastic film.

7. The object mounting system of claim 1, wherein said upper protective surface is comprised of a urethane film.

8. The object mounting system of claim 1, wherein said upper protective surface of said protective sticker is larger in area than said lower adhesive side of said adhesive tape.

9. The object mounting system of claim 1, wherein said protective sticker is thinner than said adhesive tape.

10. The object mounting system of claim 1, wherein said bottom portion of said support base is broader than said upper portion.

11. The object mounting system of claim 1, wherein said upper portion includes an interior curved portion that adjustably receives an adjustment member, wherein said object member is attached to said adjustment member.

12. The object mounting system of claim 11, wherein said adjustment member includes a curved outer surface that has approximately the same radius of curvature as an interior surface of said interior curved portion.

13. The object mounting system of claim 11, wherein said adjustment member includes an upper opening that is adapted to removably receive an object member.

14. The object mounting system of claim 13, wherein said adjustment member includes a recessed portion exposed by said upper opening, wherein said recessed portion receives an object base of said object member.

15. The object mounting system of claim 14, including an aperture extending through a side portion of said adjustment member and a securing pin that extends through said aperture into a groove within an outer sidewall of said object base to selectively retain said object member attached to said adjustment member.

16. The object mounting system of claim 11, including a fastener, wherein said adjustment member includes an interior cavity exposed by said upper opening and an adjustment opening that extends through a bottom portion of said adjustment member, wherein said fastener extends through said adjustment opening to secure said adjustment member in a desired attitude with respect to said upper portion of said support base.

17. The object mounting system of claim 16, wherein said adjustment opening is comprised of a slot.

18. The object mounting system of claim 1, wherein said bottom portion of said support base includes a passage that extends into said bottom surface of said support base, wherein said passage extends between opposing ends of said support base.

19. The object mounting system of claim 18, wherein said passage is comprised of a straight configuration.

20. An object mounting system, comprising:
a support base having a bottom portion having a bottom surface and an upper portion;
an adjustment member adjustably positioned within said upper portion of said support base to allow for adjustment of an attitude of said adjustment member;
an object member removably attached to said adjustment member;
a protective sticker having an upper protective surface and a lower adhesive surface, wherein said lower adhesive surface removably attaches to a mounting surface; and
an adhesive tape having an upper adhesive side that is adapted to attach to said bottom surface of said support base and a lower adhesive side that is adapted to removably attach to said upper protective surface of said protective sticker.
